(19) United States
(12) Patent Application Publication
(10) Pub. No.: US 2006/0276099 A1
(43) Pub. Date: Dec. 7, 2006

(54) Method of manufacturing a field emitting electrode

(75) Inventors: Teunis Johannes Vink, Eindhoven (NL); Johannes Marra, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/554,596

(22) PCT Filed: Apr. 26, 2004
(86) PCT No.: PCT/IB04/50506

§ 371 Date: Oct. 27, 2005

(30) Foreign Application Priority Data
Apr. 28, 2003 (EP) 03101157.0

(51) Int. Cl. H01J 9/02

(52) U.S. Cl. 445/35

(57) ABSTRACT

This invention relates to a method of manufacturing an field emission electrode, including a field emission electrode substrate (1) and a plurality of emitter particles (2) arranged on said field emission electrode substrate (1), comprising the steps of:—dispersing said emitter particles (2) as aerosolized emitter particles (2) in a carrier gas stream;—electrically charging said emitter particles (2); and—directing said charged emitter particles (2) in the carrier gas stream via at least one outlet towards the field emission electrode substrate (1) while maintaining an electric field between the substrate (1) and a deposition electrode (10) near the outlet, whereafter said emitter particles (2) are deposited on and adhered to said field emission electrode substrate (1).

This invention relates to a method of manufacturing a field emitting electrode.

Currently, the interest for devices based on field emission technology is increasing. The basic principle behind field emission is that electrons are forced from the surface of a cathode comprising an emitter material, when a electrical field is applied between the cathode and an anode arranged in proximity with said cathode. The stream of emitted electrons reaching the anode is used to produce light. This technology may for example be used for producing for example field emission displays and field emission lamps, for illumination purposes.

In the field of field emission displays (FED), many options are present for the emitter cathode, and the material of the emitter. However, some prior art methods for manufacturing an field emitter require complex deposition steps and/or photolithographic structuring. Examples of such emitters are the Spindt emitters, manufactured by the companies Motorola, Candescent and Pixtech, the MIM emitter, manufactured by Hitachi, and the BSD emitter manufactured by Matsushita. Consequently, efforts have been made to come up with alternative manufacturing technologies that are more straightforward to implement. Examples of such technologies are printable carbon nanotubes (CNT) and printable field emitters (PFE). However, the above printing technologies also have a number of disadvantages. First, anisometric particles, such as CNTs are distributed randomly in the printed layer on the surface of the emitter cathode, and are hence not aligned or oriented with respect to an applied electric field between the cathode and the gate electrode in a gated field emission display or between the cathode and the anode in a field emission lamp. This implies that only a minority of the particles will contribute to the field emission from the emitter. Secondly, the emitter is to be patterned either with direct printing or by a photo-lithographic structuring step when a photosensitive component has been added to the printing material. However, the accuracy of direct printing is limited, and may therefore not be useable for smaller gate hole sizes, whereas for the photo-lithographic patterning this drawback may be avoided at the expense of adding more technological processing steps. Yet an alternative is to use directly grown CNTs, in which case CNTs are deposited on the cathode on preferred locations thereof, using a patterned layer of catalyst particles. This method has the advantage that directly grown CNTs grow perpendicular to the cathode substrate surface, and are therefore well aligned with respect to the electric field applied in a gated field emission structure (e.g. a field emission display). In addition, the CNTs are also well aligned with respect to an applied electric field between the cathode and the anode. However, this method has the drawbacks that it requires optimal control of the catalyst layer and that it is quite expensive, as it uses a high-temperature CVD-technique in order to grow the CNTs.

Hence, an alternative method of manufacturing a field emission cathode is desired, overcoming the above-mentioned drawbacks with the prior art.

An object of this invention is hence to achieve a method of manufacturing a field emission cathode being simple to realize. Yet an object of this invention is to achieve a method of manufacturing a field emission cathode in which it is possible to have a good control over the patterned or selective deposition and alignment of the (anisometric) emitting particles on the cathode.

The above and other objects of the invention are at least in part achieved by a method according to claim 1. The invention is aimed towards a method of manufacturing an field emission electrode, including a field emission electrode substrate and a plurality of emitter particles arranged on said field emission electrode substrate. The inventive method comprises the steps of dispersing said emitter particles as aerosolized emitter particles in a carrier gas stream; electrically charging said emitter particles; and directing said charged emitter particles in the carrier gas stream via at least one outlet towards the field emission electrode substrate, while maintaining an electric field between the substrate and a deposition electrode near the outlet, whereafter said emitter particles are deposited on and adhered to said field emission electrode substrate. By controlling the carrier gas flow and the electrical field strength between the deposition electrode and the field emission substrate, the charged emitter particles follow strictly determined pathways towards the substrate which provides accurate control on the deposition uniformity of the emitter particles on the substrate. Especially the influence of gravity and consequently any undesirable deposition of contaminating dust particles onto the substrate during the deposition of aerosolized charged emitter particles can be avoided by an upside-down positioning (anti-gravitational) of the substrate such that the deposition of particles on the substrate is opposed by the influence of gravity. The electric field is not necessarily generated by means of the deposition electrode and electrodes on the field emission electrode substrate itself. In a preferred embodiment the side of the field emission electrode substrate facing away from the deposition electrode is coupled to a further electrode for generating the electric field between the field emission electrode substrate and the deposition electrode. This further electrode may be in (electrical) contact with the substrate, but may also be capacitively coupled to the substrate, e.g. when the further electrode is embedded in a further plate (e.g. a deposition table). Adhesion of emitter particles to the substrate may for example be realized by utilizing the van der Waals forces existing between each particle and the substrate. The aerosolized charged emitter particles line up with an applied electrical field between the field emission electrode substrate and a deposition electrode used to direct said emitter particles in the carrier gas stream towards the field emission electrode substrate. The applied electrical field induces emitter particle alignment during emitter particle deposition on the field emission electrode substrate, and this aligns the deposited emitter particles in a direction essentially perpendicular to the surface of the field emission electrode substrate. Such an emitter particle orientation results in a field enhancement, since the edge tips of each emitter particle are pointed substantially in the direction of the applied field between the gate electrode and the cathode electrode in a gated field emission display, and between the anode and the cathode in a field emission lamp device. Hence, with a field emission electrode manufactured according to this invention, a high emission current from the emitter particles may be achieved at a low voltage, applied to said electrode. Suitably, said emitting particles are anisometric particles, such as graphite flakes, rods, wires, carbon nanotubes or a combination thereof.

Preferably, the step of electrically charging said aerosolized emitter particles comprises the step of providing an essentially equal charge to each of said emitter particles. By providing essentially the same charge to all aerosolized emitter particles, they will repel each other in an even fashion, ensuring a certain distance between each particle. Together with the hydrodynamic influence of the carrier gas flow and the applied electrical field on the motion of the aerosolized charged emitter particles inside the space bounded by the deposition electrode and the substrate, the charge on the emitter particles will cause the deposited emitter particles to become dispersed evenly over the surface of the substrate, avoiding clustering of emitter particles on the substrate surface, and also resulting in a higher emission.

Since the emitter particles are charged, the deposition of the particles onto the substrate may be done either homogeneously or pattern-wise. According to one embodiment of the invention, the method further comprises the step of applying, to said field emission electrode substrate, a potential, that is essentially equal over the entire substrate, in order to achieve an even distribution of deposited emitter particles on said substrate. This may be advantageous when manufacturing a field emission light source, when an even distribution of light, due to emission, is desired. According to another embodiment of this invention, the charged emitter particles are patternwise and selectively deposited on predefined parts of the substrate by introducing a locally higher electric field strength at the area of predefined parts. In a preferred embodiment the predefined parts of the field emission substrate are formed by exposed surface parts of the emitter cathode that are surrounded by a gate electrode as encountered in gated field emission displays. The latter embodiment is a substantial advantage when manufacturing a field emission display, since the emitter particles in this case may be selectively deposited into so-called normal gated structures having gate holes on the substrate, and/or on the metal/insulator patches of a bottom gated structure on the substrate. The selective deposition may be achieved by adjusting the voltages to the gate and the cathode electrodes, respectively, such that the electric field becomes locally highest at the location of the exposed cathode in the gate structures. For example, by positively biasing the gate electrode in relation to the cathode electrode in a normal gated structure, the emitter particles will be selectively deposited into the center of the gate hole on the exposed part of the cathode, since the electrical field is highest there. Generally, the emitter particles will deposit at those locations where the electrical field is locally highest. These are the very same sites from which field-induced electron emission will occur.

As stated above, the adherence of the emitter particles is mainly governed by the van der Waals forces. However, in some instances an improved adhesion is desired. In these cases the method also comprises the step of applying a layer of adhesive material to a surface of said field emission electrode substrate, in order to improve the adherence of said emitter particles to said field emission electrode substrate. As an example, such an adhesion layer, or glue layer, may be constituted by a silver colloidal suspension, which may be applied in a thin film form on the surface of said field emission electrode substrate, and which may be cured after deposition of the emitter particles. Alternatively, a thin film of polyvinyl-alcohol (PVA) may be applied to the surface of said field emission electrode substrate prior to depositing emitter particles onto the field emission electrode substrate. When exposed to a humid atmosphere, the PVA film absorbs moisture, which results in a softening of the PVA film thereby becoming adhesive towards emitter particles that are in physical contact with the PVA film. The particles firmly adhere to the PVA film after the film has been subjected to drying. Other adhesive materials, such as materials used in printing pastes for carbon nanotubes, may also be used.

The present invention will hereinafter be described in closer detail by means of presently preferred embodiments thereof, with reference to the accompanying drawings.

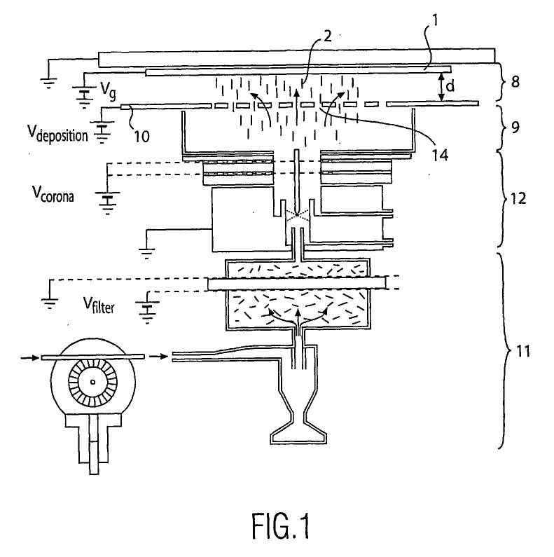

FIG. 1 discloses a schematic drawing of an example apparatus for performing the method according to the invention.

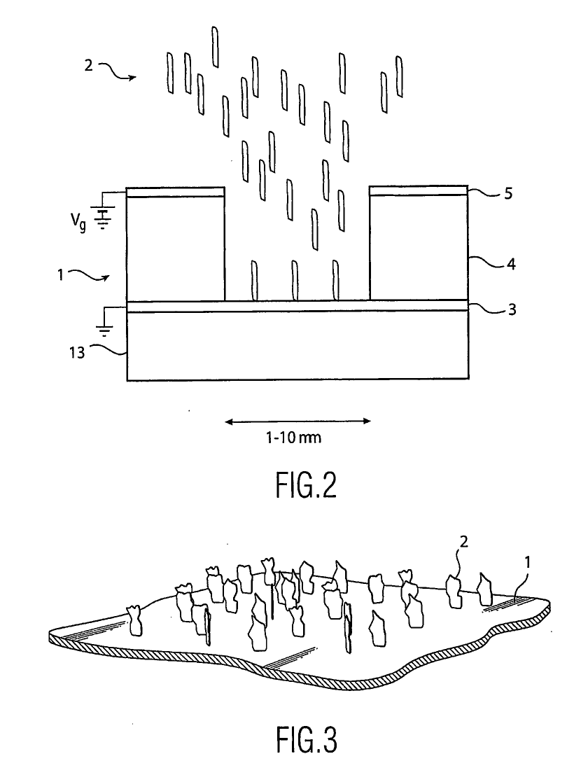

FIG. 2 discloses a schematic drawing of the area close to a substrate, when depositing emitter particles onto said substrate by means of the inventive method, and

FIG. 3 is a schematic drawing of a field emitting device manufactured according to this invention.

FIG. 2 shows a field emission electrode substrate 1 onto which emitting particles 2 are about to be deposited according to this invention. In the example in FIG. 2, the substrate has a normal gated structure, for example to be used in a field emission device. It shall however be noted that the inventive method is equally applicable to other substrate shapes, such as plane substrates.

The substrate of FIG. 2 comprises a carrier 13 onto which a conducting cathode layer 3, for example composed of a metallic material, is deposited. The cathode layer 3 is partly covered by a dielectric layer 4, onto which a conducting gate electrode layer 5 is present. From above, the cathode layer 3 is accessible through openings in the dielectric layer 4 and the gate layer 5, so-called gate holes 6. Electric potentials are independently applied to both the gate layer 5 and the cathode layer 3. In the present example, the cathode layer 3 is connected to earth potential, and the gate layer 5 is positively biased by a voltage V. with respect to the cathode layer 3. Onto the above described substrate, positively-charged field emitter particles 2 are to be selectively deposited only on predefined parts of the cathode surface 3 that are exposed and surrounded by a gate electrode layer, i.e. the parts of the cathode layer surface 3 that form the bottoms of the gate holes 6 in order to achieve a field emitting electrode device.

An apparatus to be used for carrying out this invention, disclosed in FIG. 1 and which apparatus is not a part of this invention, comprises:
an aerosol generating section 11 for the aerosolization of the solid emitter particles 2, which transfers dry emitter powder particles from a compacted state into an airborne dispersed (aerosolized) state in a carrier gas stream, such as an air flow, enabling the dispersion of powders with particle sizes down to well below 1 micrometer in diameter. Size classification of the produced emitter particle aerosol may be subsequently performed by means of a dust filter (either a simple mechanical filter or a dielectric filter), which removes the larger particles and only transmits the smaller particles.
a high voltage corona charging section 12, e.g. featuring a high-voltage needle electrode and a water-wetted counter-electrode, for charging the emitter particle aerosol.
an expansion chamber 9 for the concentration homogenization of the charged emitter particle aerosol.
a deposition chamber 8 wherein an electric deposition force is applied onto said charged emitter particles, in order to deposit the said charged emitter particles on a field emission electrode substrate 1. The charged aerosol particles 2 enter into the deposition chamber 8 via at least one outlet 14 provided by a porous gauze in a higivoltage (metal) deposition electrode 10 which is set at a voltage V_{deposition}. The field emission electrode substrate 1 for the charged emitter particles to be deposited on is placed at a distance “d” from the deposition electrode 10 and positioned substantially in parallel with the deposition electrode 10. The deposition chamber 8 is physically bounded by the substantially parallel-positioned sides of the substrate 1 and a deposition electrode 10 facing each other but left substantially open to the outside environment at all other sides thus the carrier gas stream carrying the aerosolized charged emitter particles can freely flow to the entire side and along the entire side of the whole substrate 1. The substrate 1 is preferably (electrically) coupled to a further (metal) electrode set at a potential such that the charged emitter particles are always electrically drawn towards the substrate 1 by means of the electric field existing between the substrate 1 and the deposition electrode 10. If the electric field is sufficiently high, substantially all aerosolized charged emitter particles 2 are removed from the carrier gas stream and deposited onto the substrate 1 during their residence time inside the deposition chamber 8.

According to the inventive method, emitter particles 2 are aerosolized in the aerosol generating section 11 and are thereby dispersed in a carrier gas stream. The emitter particles 2 are in this example graphite flakes, but may be constituted by any anisometric particles, such as rods, wires or carbon nanotubes. The graphite flakes, with a nominal size of preferably less than about 4-10 microns, have sharp emitting edges and are favorable with respect to their emitting properties in a field emission device.

In the next step, the carrier gas stream, containing the emitter particles 2, is passed through the high voltage corona charging section 12, whereby the emitter particles 2 are electrostatically charged. Each particle will be charged with an essentially equal charge. In the present example, the emitter particles 2 are positively charged.

Thereafter, the charged emitter particles 2 in said carrier gas stream are passed into the deposition chamber 8, via said expansion chamber 9. In the deposition chamber 8, an electrical deposition field is applied between a deposition electrode 10, held at a positive voltage V_{deposition}, and the substrate 1, in which the cathode electrode is held at ground potential, as indicated above. Alternatively, the cathode electrode of the substrate 1 is electrically coupled to a further electrode held at ground potential. This applied electrical deposition field imposes a force on the positively charged emitter particles 2 into the direction of the field emission electrode substrate 1. Moreover, due to this field, the emitter particles 2 line up with the deposition field, i.e. the particles become aligned with the deposition field, as indicated in FIG. 2. Thereafter, the particles hit-and-stick to the surface of the electrode substrate while maintaining said alignment. The hit-and-stick action may be realized by utilizing the van der Waals force between the substrate and each particle. However, in order to achieve a stronger adhesion, a layer of adhesive material may be applied to the areas of the substrate surface where emitter particles are to be deposited. Such a layer may, for example, be constituted by a thin tacky silver colloidal suspension film or a moisture-swollen tacky polyvinyl-alcohol film, which may be cured after deposition of the particles. Alternatively, materials used in printing pastes for carbon nanotubes may be used. When, during the deposition of charged emitter particles 2 onto the field emission electrode substrate 1, the gate electrode layer 5 is positively biased with respect to the cathode electrode layer 3 (connected to ground potential), the charged aerosolized emitter particles 2 will be drawn into the gate hole 6 and the particles will be selectively deposited at the center of the gate hole 6, on the exposed surface part of the cathode layer, since the electrical field is locally highest there. The particles will selectively deposit at those locations where the electrical field is locally highest, and it has also been shown that these are the very same locations from which field-induced electron emission will occur.

By using the above method of depositing emitter particles on a field emission electrode substrate, a substrate with essentially vertically aligned particles may be achieved. An example of a substrate manufactured by the inventive method is shown in FIG. 3. From the perspective of field emission, this configuration is preferred, since flaky graphite emitter particles lying flat on the field emission electrode substrate will hardly emit, or only emit when extremely high electrical fields are applied. On the contrary, in the present case the edge tips of the emitter particles will be in the direction of the applied field between the gate electrode 5 and the cathode electrode (3), and hence, high emission currents at comparatively low gate voltages may be achieved. Hence, for the vertically aligned graphite flakes, a strong field enhancement (and thus a high beta factor in the Fowler-Nordheim relation) is achieved.

Moreover, as indicated above, the aerosolized charged emitter particles are all charged with essentially equal charges. Therefore, the airborne charged emitter particles will repel each other, and hence this will automatically result in an even distribution of deposited emitter particles over the surface of the field emission substrate, ensuring a certain distance between neighboring particles. In this way, clustering of emitter particles is avoided. Hence, the emission of the emitter particles in a field emission device is improved, since particles that would be in the middle of a cluster are shielded from the field, and hence would not contribute to emission.

As indicated above, since the emitter particles 2 are charged, the deposition of particles onto the substrate may be done homogeneously or pattern-wise. In the above example, pattern-wise deposition is used, since particles are only deposited on predefined parts of the cathode electrode located at the bottom of the gate holes. Generally, the selective deposition may be achieved by adjusting the voltages of the gate and cathode electrode layers with respect to each other. More generally, the patternwise and selective deposition of charged emitter particles may be achieved on predefined parts of the substrate by introducing a locally higher field strength at the area of predefined parts by applying different potentials to different areas of the substrate. On the contrary, if for example a flat substrate is held at constant potential, such as ground potential, homogeneous disposition of charged emitter particles on the substrate may be achieved. Such a field emission electrode substrate may for example be used in field emission lamps.

It shall be noted that the above-described embodiments of the invention are not to be construed as limiting the invention, but are rather given as examples of how the present invention may be realized. A man skilled in the art will be able to use the inventive method in various ways, without departing from the spirit and scope of this invention, as defined by the appended claims.

For example, it shall be noted that the cathode described above may be realized either by applying a layer 3 of conductive cathode material on the field emission electrode substrate 1 as described above, or by manufacturing the field emission electrode substrate 1 itself from a conductive cathode material.

1. A method of manufacturing an field emission electrode, including a field emission electrode substrate (1) and a plurality of emitter particles (2) arranged on said field emission electrode substrate (1), comprising the steps of:
dispersing said emitter particles (2) as aerosolized emitter particles (2) in a carrier gas stream;
electrically charging said emitter particles (2); and
directing said charged emitter particles (2) in the carrier gas stream via at least one outlet (14) towards the field emission electrode substrate (1) while maintaining an electric field between the substrate (1) and a deposition electrode (10) in proximity to the outlet, whereafter said charged emitter particles (2) are deposited on and adhered to said field emission electrode substrate (1).

2. A method according to claim 1 in which the deposition electrode (10) comprises the outlet (14).

3. A method according to claim 1 in which the charged emitter particles (2) in the electric field between the deposition electrode (10) and the field emission electrode substrate (1) move anti-gravitationally towards the field emission electrode substrate (1).

4. A method according to claim 1 in which the side of the field emission electrode substrate (1) facing away from the deposition electrode (10) is coupled to a further electrode for generating the electric field between the field emission electrode substrate (1) and the deposition electrode (10).

5. A method according to claim 1, wherein said emitting particles (2) are anisometric particles, such as graphite flakes, rods, wires, carbon nanotubes or a combination thereof.

6. A method according to claim 1, further comprising the step of, by means of applying an electrical field, emitter particle alignment during emitter particle (2) deposition on the field emission electrode substrate (1) in a direction essentially perpendicular to the surface of field emission electrode substrate (1).

7. A method according to claim 1, wherein the step of electrically charging said aerosolized emitter particles comprises the step of providing an essentially equal charge to each of said emitter particles (2).

8. A method according to claim 1, further comprising the step of applying, to said field emission electrode substrate (1), an electric potential, that is essentially equal over the entire substrate, in order to achieve an even distribution of deposited emitter particles (2) on said substrate (1).

9. A method according to claim 1, in which the charged emitter particles (2) are patternwise and selectively deposited on predefined parts of the field emission substrate (1) by introducing a locally higher electric field strength at the area of predefined parts.

10. A method according to claim 9 wherein the predefined parts of the field emission substrate (1) are formed by exposed surface parts of the emitter cathode that are surrounded by a gate electrode layer as encountered in gated field emission displays.

11. A method according to claim 1, further comprising the step of applying a layer of adhesive material to a surface of said field emission electrode substrate (1), in order to improve the adherence of said emitter particles (2) to said field emission electrode substrate (1).

12. A field emission electrode manufactured by means of the method according to claim 1.

13. A field emission display device comprising a field emission electrode manufactured by means of the method according to claim 1.

14. A field emission light source comprising a field emission electrode manufactured by means of the method according to claim 1.
